(19) United States
(12) Patent Application Publication
(10) Pub. No.: US 2026/0266350 A1
(43) Pub. Date: Sep. 10, 2026

(54) SHOCK ABSORBER

(71) Applicant: KYB Motorcycle Suspension Co.,Ltd., Gifu (JP)

(72) Inventor: Kiyoshi KUBO, Gifu (JP)

(73) Assignee: KYB Motorcycle Suspension Co.,Ltd., Gifu (JP)

(21) Appl. No.: 18/871,706

(22) PCT Filed: Aug. 24, 2023
(86) PCT No.: PCT/JP2023/030416

§ 371 Date: Dec. 4, 2024

(30) Foreign Application Priority Data
Oct. 24, 2022 (JP) 2022-169881

(51) Int. Cl. F16F 9/34; F16F 9/06; F16K 1/42

(52) U.S. Cl. CPC F16F 9/34; F16F 9/06; F16K 1/42; F16F 2222/12

(57) ABSTRACT

A shock absorber according to the present invention includes: a shock absorber main body having a cylinder, a piston inserted into the cylinder so as to be movable in an axial direction, a piston rod inserted into the cylinder and connected to the piston, and a plurality of operation chambers filled with liquid; a first passage and a bypass passage that allow communication between the operation chambers; a damping valve that is provided in the first passage and applies resistance to a flow of liquid from one operation chamber toward the other operation chamber; a check valve that is provided in the bypass passage and allows only the flow of liquid from one operation chamber toward the other operation chamber; and a needle valve that is provided in the bypass passage in series with the check valve and capable of changing a flow path area.

### TECHNICAL FIELD

The present invention relates to a shock absorber.

### BACKGROUND ART

A shock absorber is used, for example, by being interposed between a vehicle body and a wheel in a straddle vehicle and suppresses vibrations of the vehicle body and the wheel by a damping force generated during extension and contraction.

Such a shock absorber includes, for example, as disclosed in JP 2014-149057 A, a cylinder, a piston that is movably inserted into the cylinder and partitions an inside of the cylinder into an extension side chamber and a compression side chamber filled with hydraulic oil, a piston rod that is movably inserted into the cylinder and connected to the piston, a tank that stores hydraulic oil, an extension side damping valve that is provided in the piston and applies and allows resistance to a flow of hydraulic oil from the extension side chamber toward the compression side chamber, a compression side check valve that is provided in the piston and allows only a flow of hydraulic oil from the compression side chamber toward the extension side chamber, a compression side damping valve that applies resistance to a flow of hydraulic oil from the compression side chamber toward the tank, an extension side check valve that allows only a flow of hydraulic oil from the tank toward the compression side chamber, and a needle valve that is arranged in parallel with the compression side damping valve and the extension side check valve and applies resistance to the flow of hydraulic oil from the compression side chamber toward the tank.

The shock absorber configured as described above includes an adjuster that externally operates the needle valve, and the damping force generated at the time of contraction can be adjusted to be high or low by adjusting a flow path area of the needle valve by the operation of the adjuster.

### CITATION LIST

### Patent Literature

Patent Literature 1: JP 2014-149057 A

### SUMMARY OF INVENTION

### Technical Problem

In the conventional shock absorber, the damping force at the time of contraction of the shock absorber can be adjusted to be high or low by adjusting the flow path area of the needle valve. However, since the needle valve only narrows the flow path, not only the flow of hydraulic oil from the compression side chamber toward the tank but also the flow of hydraulic oil from the tank toward the compression side chamber is allowed.

Therefore, in the conventional shock absorber, when the damping force at the time of contraction is adjusted by changing the flow path area of the needle valve, the resistance applied to the flow of hydraulic oil from the tank toward the compression side chamber by the needle valve at the time of extension of the shock absorber also changes, so that characteristics of the damping force at the time of extension of the shock absorber also change.

The same applies to a shock absorber in which a passage that bypasses the damping valve provided in the piston and allows communication between the extension side chamber and the compression side chamber is provided in the piston rod, and the needle valve is accommodated in the passage. The needle valve allows the hydraulic oil to pass through the extension side chamber and the compression side chamber in both directions, so that a change in the flow path area of the needle valve causes a change in the damping force at the time of extension and contraction of the shock absorber.

Therefore, an object of the present invention is to provide a shock absorber capable of changing only a damping force at the time of extension or contraction even when the shock absorber includes a needle valve.

### Solution to Problem

In order to solve the above problems, a shock absorber according to the present invention includes: a shock absorber main body having a cylinder, a piston inserted into the cylinder so as to be movable in an axial direction, a piston rod inserted into the cylinder and connected to the piston, and a plurality of operation chambers filled with liquid; a first passage and a bypass passage that allow communication between the operation chambers; a damping valve that is provided in the first passage and applies resistance to a flow of liquid from one operation chamber toward the other operation chamber; a check valve that is provided in the bypass passage and allows only the flow of liquid from one operation chamber toward the other operation chamber; and a needle valve that is provided in the bypass passage in series with the check valve and capable of changing a flow path area.

In the shock absorber configured as described above, since the check valve blocks the bypass passage in one of an extension stroke or a contraction stroke of the shock absorber, the needle valve can adjust only a damping force of the other of the extension stroke or the contraction stroke of the shock absorber without affecting a damping force of the one of the extension stroke or the contraction stroke at all.

### BRIEF DESCRIPTION OF DRAWINGS

FIG. 1 is a longitudinal sectional diagram of a shock absorber according to an embodiment as viewed from a front.

FIG. 2 is a diagram illustrating a rear cushion unit attached to a straddle vehicle.

FIG. 3 is a longitudinal sectional diagram of the shock absorber according to the embodiment as viewed from a side.

FIG. 4 is a hydraulic circuit diagram of the shock absorber according to the embodiment.

FIG. 5 is a cross-sectional diagram of a check valve and a needle valve of the shock absorber according to the embodiment.

FIG. 6 is a cross-sectional diagram of a damping valve of the shock absorber according to the embodiment.

FIG. 7 is a cross-sectional diagram of a modification of the check valve and the needle valve of the shock absorber according to the embodiment.

FIG. 8 is a schematic longitudinal sectional diagram of a first modification of the shock absorber of one embodiment.

### DESCRIPTION OF EMBODIMENTS

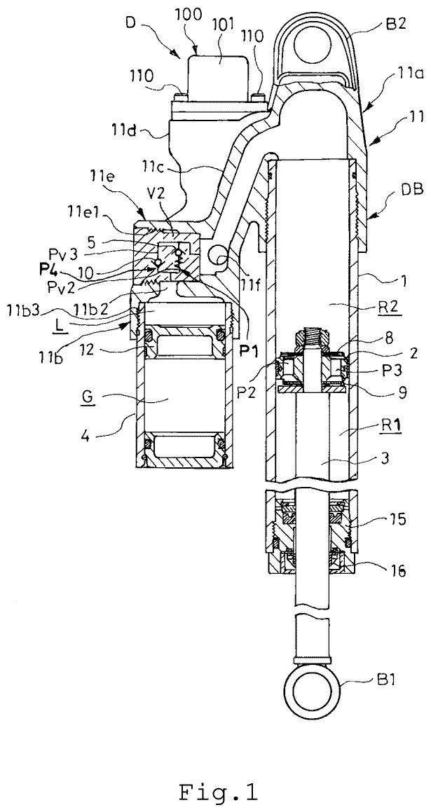

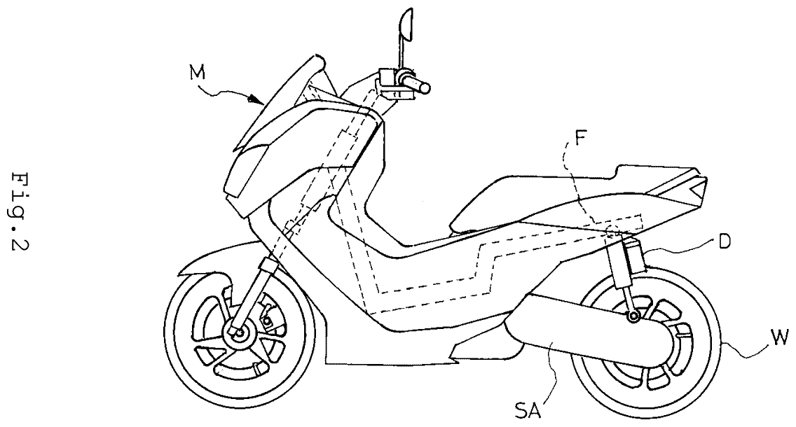

Hereinafter, the present invention will be described based on an embodiment illustrated in the drawings. As illustrated in FIGS. 1 and 2, a shock absorber D according to the embodiment includes: a shock absorber main body DB including a cylinder 1, a piston 2 that is movably inserted into the cylinder 1 and partitions an inside of the cylinder 1 into an extension side chamber R1 and a compression side chamber R2 filled with liquid, a piston rod 3 that is movably inserted into the cylinder 1 and is connected to the piston 2, and a tank 4 that stores liquid; a first passage P1 and a bypass passage PB that allow communication between operation chambers by using the compression side chamber R2 and the tank 4 as the operation chambers; a compression side damping valve 5 as a damping valve that is provided in the first passage P1 and applies resistance to a flow of liquid from the compression side chamber R2 as one operation chamber toward the tank 4 as the other operation chamber; a check valve 6 that is provided in the bypass passage PB and allows only the flow of liquid from the compression side chamber R2 toward the tank 4; and a needle valve 7 that is provided in the bypass passage PB in series with the check valve 6 and capable of changing a flow path area.

As illustrated in FIG. 2, the shock absorber D is interposed between a vehicle body F and a rear wheel W in a straddle vehicle M such as a motorcycle and is used to suppress vibrations of the vehicle body F and the rear wheel W. The shock absorber D may be used to suppress vibrations other than that of the straddle vehicle M.

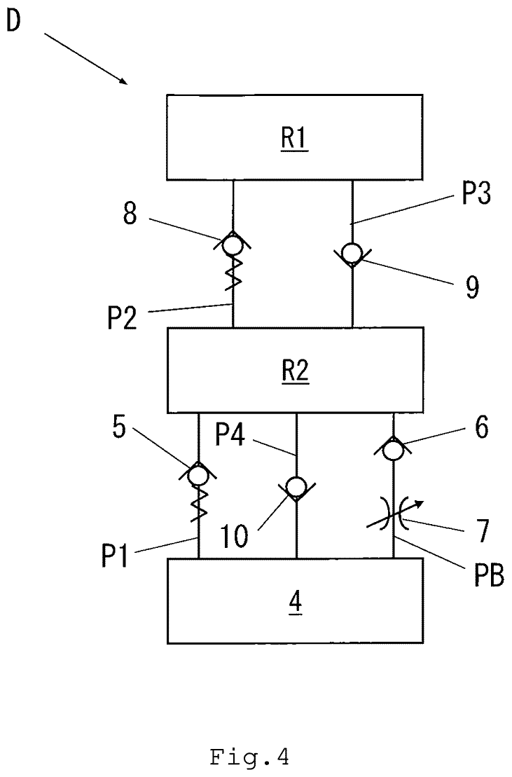

Each unit of the shock absorber D will be described in detail below. As illustrated in FIG. 1, the shock absorber main body DB of the present embodiment includes a cylinder 1, a piston 2 that is movably inserted into the cylinder 1 and partitions an inside of the cylinder 1 into an extension side chamber R1 and a compression side chamber R2 filled with liquid, a piston rod 3 that is movably inserted into the cylinder 1 and connected to the piston 2, and a tank 4 that stores liquid. In addition to the shock absorber main body DB, the first passage P1, the bypass passage PB, the compression side damping valve 5, the check valve 6, and the needle valve 7, the shock absorber D of the present embodiment includes a second passage P2 and a third passage P3 that allow communication between the extension side chamber R1 and the compression side chamber R2 in parallel, a suction passage P4 that allows communication between the compression side chamber R2 and the tank 4, an extension side damping valve 8 that is provided in the second passage P2 and applies resistance to a flow of liquid from the extension side chamber R1 toward the compression side chamber R2, a compression side check valve 9 that is provided in the third passage P3 and allows only a flow of liquid from the compression side chamber R2 toward the extension side chamber R1, and an extension side check valve 10 that is provided in the suction passage P4 and allows only a flow of liquid from the tank 4 toward the compression side chamber R2 as illustrated in the circuit diagram in FIG. 4.

An upper cap 11 is mounted to an upper end in FIG. 1 of the cylinder 1 by screw fastening, and an opening at the upper end of the cylinder 1 is closed by the upper cap 11.

At a lower end in FIG. 1 of the cylinder 1, a rod guide 15 having an annular shape and an inner periphery through which the piston rod 3 is inserted is attached.

The rod guide 15 is slidably in contact with an outer periphery of the piston rod 3 and guides the movement in an axial direction of the piston rod 3 with respect to the cylinder 1.

An annular seal member 16 is attached to a lower end in FIG. 1 of the rod guide 15. The seal member 16 is slidably in contact with the outer periphery of the piston rod 3 inserted through the inner periphery to seal between the piston rod 3 and the rod guide 15, thereby sealing the inside of the cylinder 1. The seal member 16 may be attached to the cylinder 1 instead of the rod guide 15. Further, the means for fixing the rod guide 15 and the seal member 16 to the cylinder 1 can be changed in design in any manner.

The piston 2 partitions the inside of the cylinder 1 into the extension side chamber R1 and the compression side chamber R2 filled with liquid. Note that although the liquid is hydraulic oil in the present embodiment, it is also possible to use liquid such as water and an aqueous solution in addition to the hydraulic oil, for example.

A bracket B1 that can be connected to a swing arm SA holding the rear wheel W in the straddle vehicle M is attached to the lower end in FIG. 1 of the piston rod 3 inserted into the cylinder 1 and connected to the piston 2.

The piston 2 includes a second passage P2 and a third passage P3 that allow communication between the extension side chamber R1 and the compression side chamber R2 in parallel. Further, the piston 2 includes an extension side damping valve 8 capable of opening and closing the second passage P2 and applying resistance to a flow of hydraulic oil from the extension side chamber R1 toward the compression side chamber R2, and a compression side check valve 9 capable of opening and closing the third passage P3 and allowing only a flow of hydraulic oil from the compression side chamber R2 toward the extension side chamber R1.

The extension side damping valve 8 only needs to be a valve that can exert a damping force that hinders extension of the shock absorber D during an extension stroke of the shock absorber D by applying resistance to the flow of hydraulic oil from the extension side chamber R1 toward the compression side chamber R2. Specifically, the extension side damping valve 8 is a stacked leaf valve that is formed by stacking a plurality of annular plates at the upper end in FIG. 1 of the piston 2, has an inner peripheral side fixed, and opens the second passage P2 when the outer peripheral side is deflected by the pressure of the extension side chamber R1.

The compression side check valve 9 only needs to be a valve that can allow only a flow of hydraulic oil from the compression side chamber R2 toward the extension side chamber R1 without applying much resistance during a contraction stroke of the shock absorber D. Specifically, the compression side check valve 9 is configured by a leaf valve that overlaps the lower end in FIG. 1 of the piston 2 and has a fixed inner periphery, and opens the second passage P2 when the outer peripheral side is deflected by the pressure of the compression side chamber R2.

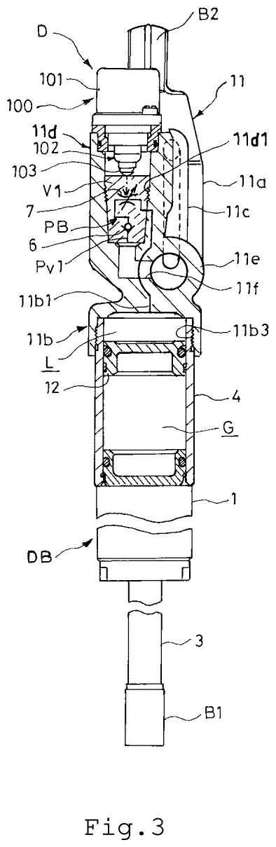

In the present embodiment, as illustrated in FIGS. 1 and 3, the upper cap 11 includes a cap portion 11a mounted to the upper end in FIG. 1 of the cylinder 1, a tank holding portion 11b that holds the tank 4, a tubular connection portion 11c that extends from the side of the cap portion 11a and is connected to the tank holding portion 11b, a tubular first housing 11d as a housing that is provided between the connection portion 11c and the tank holding portion 11b and accommodates a first valve unit V1 including the check valve 6 and the needle valve 7, and a tubular second housing 11e that is provided between the connection portion 11c and the tank holding portion 11b and accommodates a second valve unit V2 including the compression side damping valve 5 and the extension side check valve 10.

The cap portion 11a is a tubular cap having a top and is screwed to the upper end in FIG. 1 of the cylinder 1 to close the upper end of the cylinder 1, and includes a bracket B2 that can be connected to the vehicle body F of the straddle vehicle M on the upper side in FIG. 1 which is the top portion. The connection portion 11c has a tubular shape, protrudes from the side of the cap portion 11a, is curved downward in FIG. 3, and is connected to the socket-shaped tank holding portion 11b via the first housing 11d and the second housing 11e. The inside of the connection portion 11c communicates with the inside of the compression side chamber R2 in the cylinder 1 via the inside of the cap portion 11a.

The tank holding portion 11b is a tubular cap having a top, an upper end thereof is integrally connected to the first housing 11d and the second housing 11e, and a screw portion 11b3 is provided on an inner periphery of a lower end thereof. The tubular tank 4 is screwed to the screw portion 11b3 on the inner periphery of the lower end of the tank holding portion 11b.

In the present embodiment, the tank 4 has a tubular shape and is screwed to the tank holding portion 11b.

Then, a free piston 12 is slidably inserted into the tank 4, and the tank 4 is partitioned into a liquid chamber L filled with hydraulic oil by the free piston 12 and a gas chamber G filled with gas. The gas is sealed in the gas chamber G so that at least a pressure in the gas chamber G becomes equal to or higher than the atmospheric pressure when the shock absorber D is fully extended. The partition between the liquid chamber L and the gas chamber G in the tank 4 may use a diaphragm, a bladder, or the like other than using the free piston 12.

The liquid chamber L in the tank 4 communicates with the inside of the first housing 11d via a port 11b1 provided in the tank holding portion 11b, and communicates with the inside of the second housing 11e via a port 11b2 provided in the tank holding portion 11b.

As illustrated in FIG. 3, the first housing 11d has a tubular shape in which the lower end serving as a bottom portion is closed, and is integrally provided along a vertical direction on the side of the connection portion 11c, and the lower end serving as the bottom portion side is integrated with the connection portion 11c and the tank holding portion 11b. As illustrated in FIG. 1, the second housing 11e has a tubular shape with a closed bottom portion, and is provided laterally between the lower end of the connection portion 11c and the upper end of the tank holding portion 11b.

A lateral hole 11f is provided at the bottom portion of the first housing 11d and the bottom portion of the second housing 11e, and the inside of the first housing 11d and the inside of the second housing 11e communicate with each other via the lateral hole 11f. The inside of the connection portion 11c communicates with the inside of the second housing 11e. Since the inside of the connection portion 11c communicates with the compression side chamber R2 as described above, the inside of the first housing 11d communicates with the compression side chamber R2 via the lateral hole 11f, the inside of the second housing 11e, and the inside of the connection portion 11c, and the inside of the second housing 11e communicates with the compression side chamber R2 via the lateral hole 11f. Therefore, the liquid chamber L communicates with the compression side chamber R2 via the port 11b1, the inside of the first housing 11d, the lateral hole 11f, the inside of the second housing 11e, and the inside of the connection portion 11c, and communicates with the compression side chamber R2 via the port 11b2, the inside of the second housing 11e, and the inside of the connection portion 11c.

The port 11b1, the inside of the first housing 11d, the lateral hole 11f, the inside of the second housing 11e, and the inside of the connection portion 11c form the bypass passage PB that allows communication between the compression side chamber R2 and the tank 4, and the port 11b2, the inside of the second housing 11e, and the inside of the connection portion 11c form the first passage P1 and the suction passage P4 that allow communication between the compression side chamber R2 and the tank 4. Note that the arrangement and installation directions of the first housing 11d and the second housing 11e with respect to the cap portion 11a are not limited to the above-described arrangement and installation directions, and can be changed in design.

As illustrated in FIG. 3, a screw portion 11d1 is formed on an inner periphery of an opening end of the first housing 11d, and the first valve unit V1 accommodated in the first housing 11d is screwed to the screw portion 11d1. The first valve unit V1 includes a passage Pv1 that allows communication between the lateral hole 11f and the port 11b1, and the check valve 6 and the needle valve 7 provided in series with the passage Pv1. The check valve 6 allows only the flow of the hydraulic oil flowing from the compression side chamber R2 communicating with the lateral hole 11f toward the tank 4 communicating with the port 11b1 through the passage Pv1, and sets the passage Pv1 forming a part of the bypass passage PB as a one-way passage. The needle valve 7 is a valve that changes a flow path area by driving a linear actuator 100 attached to the opening end of the first housing 11d, and changes the resistance applied to the flow of the passing hydraulic oil by changing the flow path area. Therefore, the check valve 6 sets the bypass passage PB as a one-way passage from the compression side chamber R2 toward the tank 4, and the needle valve 7 applies resistance to the flow of the hydraulic oil passing through the bypass passage PB from the compression side chamber R2 toward the tank 4.

As illustrated in FIG. 1, a screw portion 11e1 is formed on the inner periphery of the opening end of the second housing 11e, and the second valve unit V2 accommodated in the second housing 11e is screwed to the screw portion 11e1.

As illustrated in FIG. 1, the second valve unit V2 includes passages Pv2 and Pv3 that allow communication between the inside of the connection portion 11c and the port 11b2 in parallel, the compression side damping valve 5 provided in the passage Pv2, and the extension side check valve 10 provided in the passage Pv3. The compression side damping valve 5 allows only the flow of the hydraulic oil flowing from the compression side chamber R2 communicating with the inside of the connection portion 11c toward the tank 4 communicating with the port 11b2 through the passage Pv2, applies resistance to the flow of the hydraulic oil passing therethrough, and sets the passage Pv2 as a one-way passage. The passage Pv2 allows communication between the inside of the connection portion 11c and the port 11b2 to form a part of the first passage P1, and the compression side damping valve 5 applies resistance to the flow of the hydraulic oil passing from the compression side chamber R2 toward the tank 4. The extension side check valve 10 allows only the flow of the hydraulic oil flowing from the tank 4 communicating with the port 11b2 toward the compression side chamber R2 communicating with the inside of the connection portion 11c through the passage Pv3, and sets the passage Pv3 as a one-way passage. The passage Pv3 allows communication between the inside of the connection portion 11c and the port 11b2 to form a part of the suction passage P4.

The shock absorber D configured as described above operates as follows. In the extension stroke of the shock absorber D in which the piston 2 moves downward in FIG. 1 with respect to the cylinder 1, the hydraulic oil moves from the extension side chamber R1 compressed by the piston 2 to the compression side chamber R2 via the second passage P2. In the extension stroke, the shock absorber D generates an extension side damping force that hinders extension by the extension side damping valve 8 applying resistance to the flow of the hydraulic oil passing through the second passage P2.

In the extension stroke of the shock absorber D, since the piston rod 3 retracts from the cylinder 1, the hydraulic oil corresponding to the volume of the piston rod 3 retracting from the cylinder 1 becomes insufficient in the compression side chamber R2. However, the hydraulic oil corresponding to the insufficient amount is supplied to the compression side chamber R2 via the suction passage P4 by the extension side check valve 10 being opened, from the liquid chamber L of the tank 4 by the free piston 12 moving within the tank 4 and expanding the gas chamber G. In the extension stroke of the shock absorber D, the compression side damping valve 5 as a damping valve is closed to block the first passage P1, and the check valve 6 is also closed to block the bypass passage PB. Therefore, the characteristics of the damping force in the extension stroke of the shock absorber D are determined by the extension side damping valve 8, and the needle valve 7 does not affect the damping force in the extension stroke.

On the other hand, in the contraction stroke of the shock absorber D in which the piston 2 moves upward in FIG. 1 with respect to the cylinder 1, the hydraulic oil in the compression side chamber R2 compressed by the piston 2 opens the compression side check valve 9 and moves to the extension side chamber R1 via the third passage P3. In addition, since the piston rod 3 enters the cylinder 1 during the contraction stroke of the shock absorber D, the amount of the hydraulic oil corresponding to the volume of the piston rod 3 entering the cylinder 1 becomes excessive in the cylinder 1. When a contraction speed of the shock absorber D is low and a pressure of the compression side chamber R2 does not reach a valve opening pressure of the compression side damping valve 5, the excessive hydraulic oil is discharged to the liquid chamber L in the tank 4 via the bypass passage PB by opening only the check valve 6.

When the contraction speed of the shock absorber D increases and the pressure of the compression side chamber R2 reaches the valve opening pressure of the compression side damping valve 5, the excessive hydraulic oil is discharged to the liquid chamber L in the tank 4 via the first passage P1 and the bypass passage PB by opening not only the check valve 6 but also the compression side damping valve 5. In the tank 4 from which the hydraulic oil is discharged, the free piston 12 moves in the tank 4 to reduce the gas chamber G.

As described above, in the contraction stroke of the shock absorber D, the hydraulic oil moves from the compression side chamber R2 toward the tank 4 only through the needle valve 7 or through the compression side damping valve 5 and the needle valve 7 according to the contraction speed of the shock absorber D. As described above, in the contraction stroke of the shock absorber D, when the contraction speed of the shock absorber D is low, the bypass passage PB is opened and the extension side chamber R1 and the compression side chamber R2 in the cylinder 1 are in a communicating state, and the needle valve 7 applies resistance to the flow of the hydraulic oil from the compression side chamber R2 toward the tank 4. When the contraction speed of the shock absorber D is high, the first passage P1 and the bypass passage PB are opened and the extension side chamber R1 and the compression side chamber R2 in the cylinder 1 are in a communicating state, and the compression side damping valve 5 and the needle valve 7 apply resistance to the flow of the hydraulic oil from the compression side chamber R2 toward the tank 4.

In the contraction stroke of the shock absorber D, since the extension side chamber R1 and the compression side chamber R2 are in the communicating state through the third passage P3, the pressures in the extension side chamber R1 and the compression side chamber R2 both increase and become substantially the same pressure. In the shock absorber D of the present embodiment, an area of the piston 2 facing the extension side chamber R1 is smaller than an area of the piston 2 facing the compression side chamber R2 by the area of the piston rod 3, and thus the contracting shock absorber D exerts a damping force of a value obtained by multiplying the pressure in the cylinder 1 by the area of the piston rod 3 in a direction in which the contraction is hindered. That is, when the shock absorber D is set to a single rod type in which the piston rod 3 exists only on one side of the piston 2 described above, a damping force proportional to a cross-sectional area of the piston rod 3 is generated during the contraction stroke.

The shock absorber D includes the needle valve 7, and the resistance applied to the flow of the hydraulic oil by the needle valve 7 can be changed by adjusting the flow path area in the needle valve 7, so that the shock absorber D can adjust the compression side damping force.

As described above, since the check valve 6 blocks the bypass passage PB in the extension stroke of the shock absorber D, the needle valve 7 can adjust the damping force in the contraction stroke of the shock absorber D without affecting the damping force in the extension stroke at all. Therefore, even when the damping force in the contraction stroke of the shock absorber D is adjusted by changing the flow path area of the needle valve 7, the damping force in the extension stroke of the shock absorber D does not change, and the change in the flow path area of the needle valve 7 does not cause the change in the damping force during both the extension stroke and the contraction stroke of the shock absorber D.

Although the compression side damping valve 5 as a damping valve, the check valve 6, and the needle valve 7 have been described in principle above, specific configurations of the compression side damping valve 5, the check valve 6, and the needle valve 7 will be described below. For convenience of the component configuration, the configuration of the needle valve 7 will be described first, and the configuration of the check valve 6 will be described later.

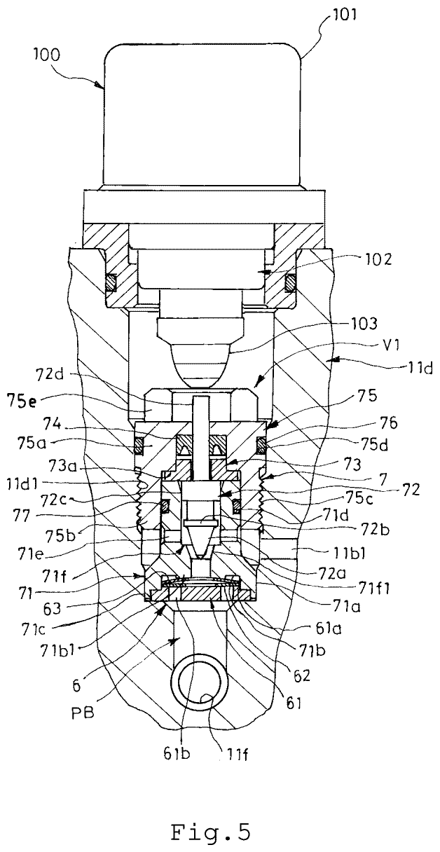

As illustrated in FIG. 5, the needle valve 7 includes a tubular needle case 71, a needle 72 inserted into the needle case 71 so as to be movable in the axial direction, and the linear actuator 100 that drives the needle 72, and is accommodated in the first housing 11d.

The needle case 71 includes a tubular diameter enlarging portion 71a that is provided at one end serving as a lower end in FIG. 5 and has an outer diameter larger than that of the other end side, an annular recess portion 71b that is provided on an inner periphery of the diameter enlarging portion 71a and has an inner diameter larger than that of the other end side, a socket portion 71c that protrudes downward from an outer periphery of an end portion of the diameter enlarging portion 71a, an annular groove 71d that is provided on an outer periphery and the other end side, a hole 71e that penetrates a wall thickness between the diameter enlarging portion 71a and the annular groove 71d in the radial direction, and an annular valve seat 71f that is provided on an inner periphery between the annular recess portion 71b and the hole 71e in the axial direction and on which the needle 72 is seated and separated.

The inner diameter of the annular recess portion 71b is smaller than the inner diameter of the socket portion 71c provided at the end portion of the diameter enlarging portion 71a and is larger than the inner diameter of the other end side of the needle case 71, so that the lower end in FIG. 5, which is one end of the needle case 71, has a shape in which the inner diameter is enlarged in two stages.

When viewed from the one end of the needle case 71, the axial end surface on the inner peripheral side of the annular recess portion 71b is shallower than the axial end surface on the outer peripheral side, and an annular ridge 71b1 is formed on the inner peripheral side of the annular recess portion 71b.

The annular groove 71d is provided along the circumferential direction on the outer periphery of a portion where the outer diameter on the other end side of the needle case 71 is small. An O-ring 77 is accommodated in the annular groove 71d.

The hole 71e penetrates between the diameter enlarging portion 71a and the annular groove 71d, that is, a portion where the outer diameter on the other end side of the needle case 71 is small in the radial direction, and allows communication between the inside and outside of the needle case 71. Therefore, the inside of the needle case 71 constantly communicates with the inside of the tank 4 via the hole 71e and the port 11b1.

The annular valve seat 71f has an annular shape and is provided on the inner periphery of the needle case 71 between the annular recess portion 71b and the hole 71e.

The inner diameter of the annular valve seat 71f is smaller than the inner diameter on the other end side of the needle case 71, and gradually increases from the partway in the axial direction toward the other end side of the needle case 71. Therefore, since the inner periphery of the annular valve seat 71f is enlarged as described above, the annular valve seat 71f includes a tapered surface 71f1 on the inner periphery.

The needle 72 has a shaft shape, and includes a conical valve head 72a that can enter the inner peripheral side of the annular valve seat 71f at the lower end in FIG. 5, a flange-shaped seat portion 72b that is provided continuously with the rear end that is the upper end in FIG. 5 of the valve head 72a and can be seated on and separated from the inner peripheral portion of the upper end of the annular valve seat 71f, a guide portion 72c that is provided at the center and has an outer diameter larger than that of another portion and is slidably in contact with the other end side of the hole 71e on the inner periphery of the needle case 71, and a guide shaft 72d that has a diameter smaller than that of another portion and protruding in the axial direction from the rear end of the guide portion 72c. The needle 72 is inserted into the needle case 71 so as to be movable in the axial direction, and the guide portion 72c is brought into sliding contact with the inner periphery of the needle case 71, whereby the needle 72 can move in the axial direction without deflection in the radial direction with respect to the needle case 71. The guide shaft 72d protrudes outward from the opening on the other end side of the needle case 71.

When the seat portion 72b is seated on the other end side surface of the annular valve seat 71f in the axial direction, the needle 72 closes the needle valve 7, and when the seat portion 72b is separated from the other end side surface of the annular valve seat 71f, a gap is generated between the valve head 72a and the tapered surface 71f1 to open the needle valve 7. When the needle valve 7 is opened, the needle valve 7 limits the flow path area of the bypass passage PB by the gap between the valve head 72a and the tapered surface 71f1, and applies resistance to the flow of the hydraulic oil passing through the needle valve 7. In addition, when the position of the needle 72 in the axial direction with respect to the needle case 71 is changed in a state where the needle valve 7 is opened, the size of the gap (flow path area) between the valve head 72a and the tapered surface 71f1 also changes, and the resistance applied to the flow of the hydraulic oil passing through the needle valve 7 also changes. As described above, by adjusting the position of the needle 72 in the axial direction with respect to the needle case 71, the flow path area of the needle valve 7 can be changed to adjust the resistance applied to the flow of the hydraulic oil passing through the needle valve 7.

Furthermore, at the upper end of the needle case 71, an annular seal pressing member 73 having an L-shaped cross section is stacked. The seal pressing member 73 includes a flange 73a on an outer periphery, and the guide shaft 72d of the needle 72 is inserted on an inner periphery. Further. A seal member 74 that has an annular shape and is slidably in contact with the outer periphery of the guide shaft 72d of the needle 72 is stacked on the upper end of the seal pressing member 73, and the outer periphery of the needle 72 is sealed by the seal member 74. The guide shaft 72d of the needle 72 protruding upward from the needle case 71 is inserted into the adapter 75, and the upper end of the guide shaft 72d constantly protrudes upward in FIG. 5 of the adapter 75.

The needle case 71 accommodating the needle 72 is fixed together with the seal pressing member 73 and the seal member 74 in the first housing 11d by a normal adapter 75 screwed to the screw portion 11d1 provided on the inner periphery of the first housing 11d. The adapter 75 has a tubular shape, and includes a small-diameter portion 75a and a large-diameter portion 75b formed on the inner periphery with an inner diameter on the upper end side in FIG. 5 reduced in two stages, a screw portion 75c that is provided on the outer periphery and screwed to the screw portion 11d1 of the first housing 11d, and an annular groove 75d that is provided on the upper side in FIG. 5 than the screw portion 75c. In the annular groove 75d of the adapter 75, a seal ring 76 that is in close contact with the inner periphery of the first housing 11d on the opening end side than the screw portion 11d1 is mounted, thereby providing a seal between the adapter 75 and the first housing 11d. In addition, in order to make it convenient for the adapter 75 to be screwed into the first housing 11d, the upper end of the adapter 75 is provided with an operating unit 75e formed of a ridge having a groove that allows insertion of a tool for rotating the adapter 75.

The seal member 74 is accommodated in the small-diameter portion 75a of the adapter 75, and in the large-diameter portion 75b of the adapter 75, the flange 73a of the seal pressing member 73 is accommodated and the needle case 71 is fitted. The flange 73a of the seal pressing member 73 is sandwiched in a step portion between the needle case 71 and the small-diameter portion 75a and the large-diameter portion 75b of the adapter 75, and the seal pressing member 73 is immovably fixed to the adapter 75 and the needle case 71. A portion of the seal pressing member 73 having a smaller diameter than the flange 73a enters the small-diameter portion 75a of the adapter 75 and faces the seal member 74 in the axial direction, thereby preventing the seal member 74 from falling off from the inside of the small-diameter portion 75a of the adapter 75.

The guide shaft 72d in the needle 72 protruding upward from the upper end of the adapter 75 is slidably in contact with the inner peripheral surface of the upper end portion of the adapter 75 having the smallest inner diameter, and axial deflection of the guide shaft 72d in the radial direction is suppressed. As described above, in the needle 72, the guide shaft 72d is slidably in contact with the inner peripheral surface of the upper end of the adapter 75, the guide portion 72c is slidably in contact with the inner peripheral surface of the needle case 71, and the needle is supported at two points, so that the needle can be seated on and separated from the annular valve seat 71f without axial deflection during axial movement, and the flow path area can be stably changed.

The linear actuator 100 is fixed to the opening end of the first housing 11d with a bolt 110. Specifically, the linear actuator 100 includes a stepping motor 101 including a rotor (not illustrated) and a conversion unit 102 including a feed screw mechanism that converts rotational motion of the rotor into linear motion of a push rod 103 and outputs the linear motion. The push rod 103 in the linear actuator 100 can abut on the guide shaft 72d at the rear end of the needle 72 inserted into the needle case 71 fixed in the first housing 11d so as to be movable in the axial direction, and when the stepping motor 101 is driven to be displaced in the axial direction of the push rod 103, the needle 72 moves in the axial direction with respect to the needle case 71. Therefore, by driving the linear actuator 100, the needle 72 can be moved close to and away from the annular valve seat 71f provided in the needle case 71, thereby adjusting the flow path area when the needle valve 7 is closed or opened.

The guide shaft 72d of the needle 72 and the push rod 103 merely abut on each other and are not connected to each other. When the needle 72 receives the pressure of the hydraulic oil that is about to pass through the inner periphery of the annular valve seat 71f of the needle case 71, the needle 72 is pressed upward in FIG. 5 with respect to the needle case 71 and abuts on the push rod 103. Therefore, when the push rod 103 is displaced upward, the needle is pressed by the hydraulic oil and is displaced upward in a direction away from the annular valve seat 71f following the displacement of the push rod 103 to increase the flow path area of the needle valve 7. On the other hand, when the push rod 103 is displaced downward in FIG. 5, the needle 72 is pushed by the push rod 103 and moves downward which is the annular valve seat 71f side with respect to the needle case 71 to reduce the flow path area of the needle valve 7. Therefore, the guide shaft 72d of the needle 72 and the push rod 103 may be simply abutted on each other without being connected, but may be connected.

In the shock absorber D of the present embodiment, the first housing 11d is provided in the upper cap 11 in the cylinder 1 along the vertical direction, and the opening end faces upward, so that the linear actuator 100 is attached to the upper side of the shock absorber D. In the shock absorber D of the present embodiment, the upper cap 11 is connected to the vehicle body F of the straddle vehicle M, and the linear actuator 100 is disposed on the vehicle body F side. Therefore, a wiring length for supplying electric power to the linear actuator 100 can be shortened, and the linear actuator 100 can be protected away from the ground.

Subsequently, the check valve 6 includes a disk-shaped valve seat member 61 fitted to the lower end in FIG. 5 of the needle case 71, an annular valve body 62 accommodated in the annular recess portion 71b of the needle case 71, movable in the axial direction with respect to the valve seat member 61, and is seated on and separated from the valve seat member 61, and an annular biasing member 63 accommodated in the inner periphery of the needle case 71 and biasing the annular valve body 62 toward the valve seat member 61, and the needle case 71 is used as a case for accommodating the annular valve body 62 and the biasing member 63.

The valve seat member 61 includes a cylindrical convex portion 61a having a disk shape and protruding in the axial direction from an end portion on the needle valve side, and a plurality of holes 61b arranged side by side on a circumference having a smaller diameter than the convex portion 61a and penetrating the wall thickness of the convex portion 61a in the axial direction. The hole 61b in the valve seat member 61 allows communication between the inside of the needle case 71 and the lateral hole 11f in the upper cap 11.

The valve seat member 61 is fitted to the end portion of the needle case 71 by inserting the convex portion 61a into the annular recess portion 71b of the needle case 71 and inserting the outer peripheral portion into the socket portion 71c. Therefore, the axial end surface of the outer peripheral portion of the valve seat member 61 on the outer periphery than the convex portion 61a abuts on the axial end surface of the diameter enlarging portion 71a. As described above, the valve seat member 61 of the check valve 6 is fitted to the inner periphery of one end of the needle case 71, and is fixed in the first housing 11d by being sandwiched between the adapter 75, which is screwed together with the needle case 71 into the first housing 11d, and the bottom portion of the first housing 11d while receiving a force in the axial direction (axial force). Specifically, the seal pressing member 73, the needle case 71, and the outer peripheral portion of the valve seat member 61 are configured to be sandwiched between the adapter 75 and the bottom portion of the first housing 11d, and receive the axial force from the adapter 75 and the bottom portion of the first housing 11d. Therefore, since the outer peripheral portion of the valve seat member 61 on the needle case side and the axial end portion of the diameter enlarging portion 71a of the needle case 71 are brought into close contact with each other by receiving the axial force, it is possible to prevent the hydraulic oil from passing between the valve seat member 61 and the needle case 71 without providing a seal. In addition, since the outer peripheral portion of the valve seat member 61 on the counter-needle case side and the bottom portion of the first housing 11d are brought into close contact with each other by receiving the axial force, it is possible to prevent the hydraulic oil from passing between the valve seat member 61 and the first housing 11d without providing a seal.

The annular valve body 62 has an annular shape, is overlapped on the valve seat member 61 so as to be movable in the axial direction as a whole, and is accommodated in the annular recess portion 71b of the needle case 71. The outer diameter of the annular valve body 62 is slightly smaller than the outer diameter of the convex portion 61a and the outer diameter of the annular recess portion 71b, and the inner diameter of the annular valve body 62 is set to a diameter that can close each hole 61b when abutting on the valve seat member 61.

The biasing member 63 is a bending washer having elasticity, is accommodated in the annular recess portion 71b of the needle case 71, and is interposed between the annular valve body 62 and the ridge 71b1 of the needle case 71 in a compressed state in the axial direction, and constantly biases the annular valve body 62 toward the valve seat member 61. Therefore, when the force pressing upward in FIG. 5 by the pressure of the compression side chamber R2 acting through the hole 61b exceeds the biasing force of the biasing member 63, the biasing member 63 is compressed in the axial direction, causing the entire annular valve body 62 to retract in the axial direction from the valve seat member 61 as a whole, thereby opening the hole 61b. When the annular valve body 62 is separated from the valve seat member 61, the hole 61b is opened, and the hydraulic oil passes through the inner periphery of the annular valve body 62 and the biasing member 63 from the compression side chamber R2 and can move to the tank 4 through the inside of the needle case 71. On the other hand, the annular valve body 62 abuts on the valve seat member 61 and closes the hole 61b until the pressure of the compression side chamber R2 exceeds the pressure of the tank 4 received from the back surface side and the differential pressure therebetween reaches the valve opening pressure of the check valve 6. The annular valve body 62 and the biasing member 63 are positioned in the radial direction by the side wall surface of the needle case 71 forming the annular recess portion 71b, and the axial deflection in the radial direction does not occur even when the annular valve body 62 and the biasing member 63 move in the direction close to and away from the valve seat member 61. This allows for stable operation and stable blocking of the hole 61b when seated on the valve seat member 61.

The biasing member 63 may be a wave washer, an annular disk spring, or an elastic body other than the bending washer because it is sufficient that the biasing member 63 can bias the annular valve body 62 and does not hinder the passage of the hydraulic oil in the needle case 71 in a state where the annular valve body 62 opens the hole 61b of the valve seat member 61.

The check valve 6 and the needle valve 7 are configured as described above, and components other than the linear actuator 100 configure the first valve unit V1 accommodated in the first housing 11d. The hole 61b in the valve seat member 61, the inside of the needle case 71, and the hole 71e form a passage Pv1 that allows communication between the lateral hole 11f communicating with the compression side chamber R2 and the port 11b1 communicating with the tank 4 and forms a part of the bypass passage PB, and the check valve 6 and the needle valve 7 are provided in series with the Pv1. When the needle case 71 is fitted into the adapter 75, the O-ring 77 accommodated in the annular groove 71d of the needle case 71 is compressed and comes into close contact with the inner peripheral surface of the large-diameter portion 75b of the adapter 75 while applying a tightening force, so that the needle case 71 can be temporarily fixed to the adapter 75. Therefore, when the O-ring 77 that is in close contact with the adapter 75 is provided on the outer periphery of the needle case 71, the needle case 71 holding the check valve 6, the needle 72, the seal pressing member 73, and the seal member 74 can be held in the adapter 75 by the O-ring 77 in the assembled state, so that the work when the first valve unit V1 is screwed to the first housing 11d is facilitated.

In a case where the needle valve 7 is opened, when the shock absorber D contracts, the annular valve body 62 is separated from the valve seat member 61 by the pressure of the compression side chamber R2 acting through the hole 61b, and the check valve 6 is opened to open the bypass passage PB. Therefore, during the contraction stroke of the shock absorber D, the check valve 6 is opened to open the bypass passage PB, and the hydraulic oil passes through the check valve 6 and the needle valve 7 provided in the bypass passage PB and moves from the compression side chamber R2 to the tank 4. The needle valve 7 applies resistance corresponding to the flow path area to the flow of the hydraulic oil.

On the other hand, when the seat portion 72b is seated on the annular valve seat 71f and the needle valve 7 is closed, the hydraulic oil cannot pass through the bypass passage PB even when the shock absorber D contracts, so that the movement of the hydraulic oil from the compression side chamber R2 to the tank 4 through the bypass passage PB is prevented.

When the shock absorber D extends regardless of the opening and closing of the needle valve 7, the check valve 6 remains closed to block the bypass passage PB, so that the hydraulic oil does not pass through the bypass passage PB.

Since the valve seat member 61, the needle case 71, and the bottom portion of the first housing 11d are in close contact with each other under the action of the axial force, the compression side chamber R2 and the tank 4 are prevented from being short-circuited without passing through the check valve 6 between the valve seat member 61 and the needle case 71, and the compression side chamber R2 and the tank 4 are prevented from being short-circuited without passing through the check valve 6 and the needle valve 7 between the valve seat member 61 and the first housing 11d. Therefore, even when a seal is not provided between the valve seat member 61 and the needle case 71 and between the valve seat member 61 and the bottom portion of the first housing 11d, the hydraulic oil can be prevented from passing through the bypass passage PB during the extension stroke of the shock absorber D, and the hydraulic oil can be prevented from moving from the compression side chamber R2 to the tank 4 without passing through the check valve 6 and the needle valve 7 during the contraction stroke of the shock absorber D.

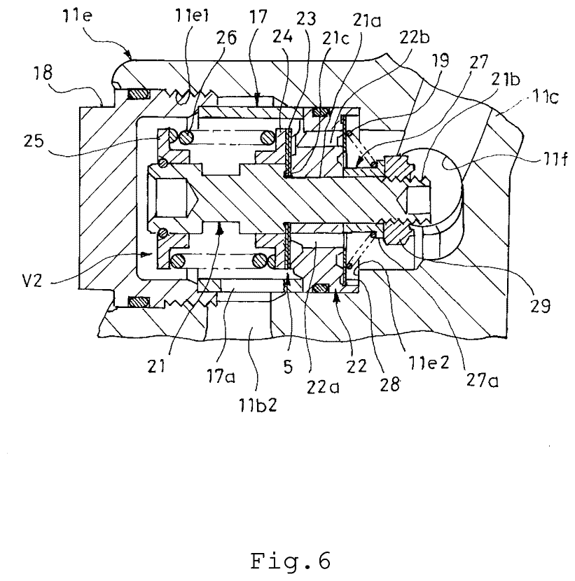

Next, the compression side damping valves 5 and extension side check valves 10 configuring the second valve unit V2 accommodated in the second housing 11e will be specifically described. As illustrated in FIG. 6, the second valve unit V2 includes a valve holding shaft 21 inserted into the second housing 11e of the upper cap 11, a disc 22 mounted to the outer periphery of the valve holding shaft 21, an annular leaf valve 23 overlapping the left end in FIG. 6 of the disc 22 and having an inner periphery fixed to the outer periphery of the valve holding shaft 21, an annular valve pressing member 24 disposed on the counter-disc side of the leaf valve 23, an annular spring seat 25 attached to the left end in FIG. 6 of the valve holding shaft 21, a spring 26 interposed between the valve pressing member 24 and the spring seat 25 to bias the leaf valve 23 toward the disc 22 via the valve pressing member 24, a tubular collar 27 overlapping the inner periphery of the right end in FIG. 6 of the disc 22 and fitted to the outer periphery of the valve holding shaft 21, an annular check valve body 28 disposed on the outer periphery of the collar 27 overlapped on the right end in FIG. 6 of the disc 22 so as to be movable in the axial direction, a nut 29 screwed to the right end in FIG. 6 of the valve holding shaft 21, a spring 19 interposed between the check valve body 28 and the collar 27 to bias the check valve body 28 toward the disc 22, a cap 18 screwed to the screw portion 11e1 of the second housing 11e, and a tubular spacer 17 interposed between the outer periphery of the disc 22 and the cap 18.

As illustrated in FIG. 6, the valve holding shaft 21 has a cylindrical shape, and includes a small-diameter portion 21a formed by reducing the outer diameter from the partway to the right end in FIG. 6 which is the distal end, and inserted into the inner periphery of the disc 22, and a screw portion 21b provided on the distal end outer periphery of the small-diameter portion 21a, and an annular spring seat 25 is attached to the outer periphery in FIG. 6, which is the base end.

The disc 22 has an annular shape and includes a port 22a passing through the wall thickness in the axial direction and a port 22b passing through the wall thickness in the axial direction. The port 22a functions as the passage Pv2 that allows communication between the inside of the connection portion 11c communicating with the compression side chamber R2 and the port 11b2 communicating with the tank 4 and forms a part of the first passage P1, and the port 22b functions as the passage Pv3 that allows communication between the inside of the connection portion 11c communicating with the compression side chamber R2 and the port 11b2 communicating with the tank 4 and forms a part of the suction passage P4.

The leaf valve 23 has an inner periphery fixed to the outer periphery of the small-diameter portion 21a of the valve holding shaft 21, is allowed to deflect on the outer peripheral side, and is overlapped on the left end in FIG. 6 of the disc 22. When the leaf valve 23 abuts on the disc 22, the port 22a is blocked, and when the outer periphery is deflected, the port 22a is opened.

The valve pressing member 24 is a tube including a flange on the outer periphery, and is overlapped on the counter-disc side of the leaf valve 23 and fitted to the outer periphery of the valve holding shaft 21 on the base end side than the small-diameter portion 21a so as to be movable in the axial direction, so that it can move close to and away from the disc 22 in the axial direction.

The spring 26 formed of a coil spring is interposed in a compressed state between the valve pressing member 24 and the spring seat 25, and the spring 26 constantly biases the leaf valve 23 toward the disc 22 so as to seat the leaf valve 23 on the disc 22 via the valve pressing member 24.

The tubular collar 27 is overlapped on the inner periphery of the right end in FIG. 6 of the disc 22 and is immovably mounted to the outer periphery of the small-diameter portion 21a of the valve holding shaft 21. The collar 27 includes a flange-shaped spring seat 27a on the outer periphery of the right end in FIG. 6. The check valve body 28 has an annular shape and an inner diameter larger than the outer diameter of the collar 27, and is overlapped on the right end in FIG. 6 of the disc 22 so as to be movable in the axial direction. When the check valve body 28 abuts on the disc 22, the port 22b is blocked, and when the check valve body 28 separates from the disc 22, the port 22b is opened. Note that in the check valve body 28, an outer periphery is guided in its axial movement by an annular guide (not illustrated) provided on the outer periphery of the disc 22, and the check valve body 28 can move close to and away from the disc 22 without axial deflection.

The nut 29 is screwed to the screw portion 21b at the distal end of the small-diameter portion 21a of the valve holding shaft 21. When the nut 29 is screwed to the valve holding shaft 21, the disc 22, the leaf valve 23, and the collar 27 are sandwiched between the nut 29 and a step portion 21c formed by providing the small-diameter portion 21a of the valve holding shaft 21, and are immovably fixed to the valve holding shaft 21.

The spring 19 formed of a conical coil spring is interposed in a compressed state between the check valve body 28 and the spring seat 27a of the collar 27, and the spring 19 constantly biases the check valve body 28 toward the disc 22 so as to seat the check valve body 28 on the disc 22.

The disc 22, the leaf valve 23, the valve pressing member 24, the spring seat 25, the spring 26, the collar 27, the check valve body 28, the nut 29, and the spring 19 configured in this manner are assembled and integrated with the valve holding shaft 21 to form a valve assembly.

When the valve assembly is inserted into the second housing 11e until the outer periphery at the right end in FIG. 6 of the disc 22 abuts on a step portion 11e2 formed in the second housing 11e, the valve assembly is completely accommodated in the second housing 11e. As described above, when the tubular spacer 17 is overlapped on the outer peripheral portion at the left end in FIG. 6 of the disc 22 in the valve assembly accommodated in the second housing 11e, and then the cap 18 for closing the second housing 11e is screwed to the screw portion 11e1 of the second housing 11e, the disc 22 and the spacer 17 are sandwiched between the cap 18 and the step portion 11e2, and the valve assembly is fixed in the second housing 11e.

The spacer 17 is provided with a through-hole 17a, and communication between the tank 4 and the inside of the second housing 11e is secured via the port 11b2 and the through-hole 17a. During the contraction stroke of the shock absorber D, the pressure of the compression side chamber R2 acts on the leaf valve 23 via the inside of the connection portion 11c and the port 22a, and when the force to deflect the outer periphery of the leaf valve 23 by the pressure overcomes the resilient force of the leaf valve 23 and the biasing force of the spring 26, the outer peripheral side of the leaf valve 23 deflects and separates from the disc 22 to open the port 22a, and allows communication between the compression side chamber R2 and the tank 4 to allow the passage of the hydraulic oil from the compression side chamber R2 toward the tank 4 and apply resistance to the flow of the passing hydraulic oil.

As described above, the port 22a forms the first passage P1 that allows communication between the compression side chamber R2 and the tank 4 together with the port 11b2, the inside of the second housing 11e, and the inside of the connection portion 11c, and forms the compression side damping valve 5 that generates the damping force during the contraction stroke of the shock absorber D by the disc 22, the leaf valve 23, the valve pressing member 24, the spring seat 25, and the spring 26. Note that the configurations of the compression side damping valve 5 and the extension side check valve 10 are merely examples, and other configurations may be adopted, and can be changed in design.

On the other hand, during the extension stroke of the shock absorber D, the pressure of the tank 4 acts on the check valve body 28 via the port 11b2 and the port 22b, and when the force to separate the check valve body 28 from the disc 22 by the pressure overcomes the biasing force of the spring 19, the check valve body 28 separates from the disc 22 and opens the port 22b to allow communication between the tank 4 and the compression side chamber R2 and allow the passage of the hydraulic oil from the tank 4 toward the compression side chamber R2.

As described above, the port 22b forms the suction passage P4 that allows communication between the compression side chamber R2 and the tank 4 together with the port 11b2, the inside of the second housing 11e, and the inside of the connection portion 11c, and the extension side check valve 10 that opens the suction passage P4 during the extension stroke of the shock absorber D is formed by the disc 22, the check valve body 28, the collar 27, and the spring 19.

When the shock absorber D including the compression side damping valve 5 as the damping valve, the check valve 6, the needle valve 7, the extension side check valve 10, the first passage P1, the bypass passage PB, and the suction passage P4 configured as described above extends, the extension side damping force that hinders the extension is generated by the extension side damping valve 8 applying resistance to the flow of the hydraulic oil passing through the second passage P2. During the extension stroke of the shock absorber D, since the check valve body 28 is separated from the disc 22 to open the port 22b, the extension side check valve 10 is opened, and the hydraulic oil corresponding to the volume of the piston rod 3 retracting from the cylinder 1 is supplied from the tank 4 to the compression side chamber R2 via the suction passage P4.

During the extension stroke of the shock absorber D, the compression side damping valve 5 as the damping valve is closed to block the first passage P1, and even when the needle 72 in the needle valve 7 is separated from the annular valve seat 71f to open the bypass passage PB, the annular valve body 62 abuts on the valve seat member 61 to close the hole 61b to block the bypass passage PB, so that the damping force characteristics in the extension stroke of the shock absorber D are determined only by the extension side damping valve 8, and the needle valve 7 does not affect the damping force in the extension stroke.

On the other hand, during the contraction stroke of the shock absorber D, the hydraulic oil in the compression side chamber R2 opens the compression side check valve 9 and moves to the extension side chamber R1 via the third passage P3, and the hydraulic oil corresponding to the volume of the piston rod 3 entering the cylinder 1 becomes excessive in the cylinder 1. In a case where the needle 72 in the needle valve 7 is separated from the annular valve seat 71f to open the bypass passage PB and the contraction speed of the shock absorber D is low and the pressure of the compression side chamber R2 does not reach the valve opening pressure of the compression side damping valve 5, the excessive hydraulic oil described above presses the annular valve body 62 to separate from the annular valve body 62 and passes through the hole 61b, and then passes through the gap between the needle 72 and the annular valve seat 71f to move from the compression side chamber R2 to the tank 4. Therefore, in this case, the shock absorber D generates a damping force that hinders contraction of the shock absorber main body DB by the needle valve 7. In addition, the resistance applied to the flow of the hydraulic oil adjusts the flow path area in the needle valve 7 by the linear actuator 100, so that the damping force during the contraction stroke of the shock absorber D can be adjusted to be high and low.

When the needle 72 in the needle valve 7 is separated from the annular valve seat 71f to open the bypass passage PB and the contraction speed of the shock absorber D is high and the pressure of the compression side chamber R2 reaches the valve opening pressure of the compression side damping valve 5, the excessive hydraulic oil not only passes through the check valve 6 and the needle valve 7 in the bypass passage PB, but also deflects the outer periphery of the leaf valve 23 to be separated from the disc 22 while pressing the spring 26 and the leaf valve 23 to compress the spring 26, and passes through the port 22a to move from the compression side chamber R2 to the tank 4. Therefore, in this case, the shock absorber D generates a damping force that hinders contraction of the shock absorber main body DB by the needle valve 7 and the compression side damping valve 5. Also in this case, since the needle valve 7 contributes to the generation of the damping force, the damping force during the contraction stroke of the shock absorber D can be adjusted to be high or low by adjusting the flow path area of the needle valve 7 by the linear actuator 100. When the needle 72 in the needle valve 7 is seated on the annular valve seat 71f to close the bypass passage PB, the hydraulic oil cannot pass through the bypass passage PB and passes only through the compression side damping valve 5, so that the shock absorber D generates a damping force that hinders contraction of the shock absorber main body DB only by the compression side damping valve 5.

As described above, since the check valve 6 blocks the bypass passage PB in the extension stroke of the shock absorber D, the needle valve 7 can adjust the damping force in the contraction stroke of the shock absorber D without affecting the damping force in the extension stroke at all. Therefore, even when the damping force in the contraction stroke of the shock absorber D is adjusted by changing the flow path area of the needle valve 7, the damping force in the extension stroke of the shock absorber D does not change, and the change in the flow path area of the needle valve 7 does not cause the change in the damping force during both the extension stroke and the contraction stroke of the shock absorber D.

As described above, the shock absorber D of the present embodiment includes: the shock absorber main body DB having the cylinder 1, the piston 2 inserted into the cylinder 1 so as to be movable in the axial direction, the piston rod 3 inserted into the cylinder 1 and connected to the piston 2, the compression side chamber R2 filled with the hydraulic oil (liquid), and the tank 4 (a plurality of operation chambers) ; the first passage P1 and the bypass passage PB that allow communication between the compression side chamber R2 and the tank 4; the compression side damping valve (damping valve) 5 that is provided in the first passage P1 and applies resistance to the flow of the hydraulic oil (liquid) from the compression side chamber (one operation chamber) R2 toward the tank (the other operation chamber) 4; the check valve 6 that is provided in the bypass passage PB and allows only the flow of the hydraulic oil (liquid) from the compression side chamber (one operation chamber) R2 toward the tank (the other operation chamber) 4; and the needle valve 7 that is provided in the bypass passage PB in series with the check valve 6 and capable of changing a flow path area.

In the shock absorber D configured as described above, since the check valve 6 blocks the bypass passage PB in the extension stroke of the shock absorber D, the needle valve 7 can adjust only the damping force in the contraction stroke of the shock absorber D without affecting the damping force in the extension stroke at all. Therefore, according to the shock absorber D of the present embodiment, even when the flow path area of the needle valve 7 is changed to adjust the damping force in the contraction stroke of the shock absorber D, the damping force in the extension stroke of the shock absorber D is not changed. Therefore, only the damping force at the time of contraction can be changed even when the needle valve 7 is provided.

Further, in the shock absorber D of the present embodiment, the shock absorber main body DB includes the extension side chamber R1 and the compression side chamber R2 partitioned by the piston 2 in the cylinder 1, and the tank 4 that stores hydraulic oil (liquid), the second passage P2 and the third passage P3 that allow communication between the extension side chamber R1 and the compression side chamber R2 in parallel, the suction passage P4 that allows communication between the compression side chamber R2 and the tank 4, the extension side damping valve 8 that is provided in the second passage P2 and applies resistance to the flow of the hydraulic oil (liquid) from the extension side chamber R1 toward the compression side chamber R2, a compression side check valve 9 that is provided in the third passage P3 and allows only the flow of the hydraulic oil (liquid) from the compression side chamber R2 toward the extension side chamber R1, and the extension side check valve 10 that is provided in the suction passage P4 and allows only the flow of the hydraulic oil (liquid) from the tank 4 toward the compression side chamber R2, in which the first passage P1 and the bypass passage PB allow communication between the compression side chamber R2 and the tank 4, with the operation chambers as the compression side chamber R2 and the tank 4, the compression side damping valve (damping valve) 5 applies resistance to the flow of the hydraulic oil (liquid) while allowing only the flow of the hydraulic oil (liquid) from the compression side chamber R2 toward the tank 4, and the check valve 6 allows only the flow of the hydraulic oil (liquid) from the compression side chamber R2 toward the tank 4. In the shock absorber D configured as described above, since the bypass passage PB is blocked by the check valve 6 during the extension stroke, when the extension speed is extremely low, the hydraulic oil can be prevented from moving to the compression side chamber R2 through the bypass passage PB and the pressure in the compression side chamber R2 can be quickly lowered, so that the generation responsiveness of the damping force can be improved.

Further, the shock absorber D of the present embodiment includes: the first housing (housing) 11d that accommodates the check valve 6 and the needle valve 7, the needle valve 7 includes the needle case 71 that has a tubular shape and is inserted into the first housing (housing) 11d and the needle 72 that is inserted into the needle case 71 so as to be movable in the axial direction, the needle case 71 has the annular recess portion 71b formed by expanding an inner diameter at one end, the check valve 6 has a disk-shaped valve seat member 61 that is sandwiched between one end side of the needle case 71 and the first housing (housing) 11d, faces the annular recess portion 71b, is in close contact with the needle case 71 and the first housing (housing) 11d, and includes a hole 61b that penetrates the wall thickness, the annular valve body 62 that is accommodated in the annular recess portion 71b so as to be movable in the axial direction and is seated on and separated from the valve seat member 61, and the annular biasing member 63 that is accommodated in the annular recess portion 71b and biases the annular valve body 62 toward the valve seat member 61, and the bypass passage PB allows communication between the compression side chamber R2 and the tank 4 via the hole 61b and the inside of the needle case 71.

According to the shock absorber D configured as described above, since the valve seat member 61 is sandwiched between the needle case 71 and the first housing (housing) 11d, the valve seat member 61, the needle case 71, and the first housing (housing) 11d can be brought into close contact with each other by applying an axial force thereto. Therefore, according to the shock absorber D configured as described above, even when a seal is not provided between the valve seat member 61 and the needle case 71 and between the valve seat member 61 and the bottom portion of the first housing (housing) 11d, the hydraulic oil can be prevented from passing through the bypass passage PB during the extension stroke of the shock absorber D, and the hydraulic oil can be prevented from moving from the compression side chamber R2 to the tank 4 without passing through the check valve 6 and the needle valve 7 during the contraction stroke of the shock absorber D.

Further, in the shock absorber D of the present embodiment, the needle case 71 includes the annular valve seat 71f on its inner periphery on which the needle 72 is seated and separated. According to the shock absorber D configured as described above, since the needle case 71 not only functions as a case of the needle valve 7 including the annular valve seat 71f and accommodating the needle 72 but also functions as a case accommodating the annular valve body 62 and the biasing member 63, the check valve 6 and the needle valve 7 can be disposed in series in close proximity to each other, and the entire check valve 6 and the needle valve 7 can be downsized. Therefore, according to the shock absorber D configured as described above, it is possible to avoid an increase in size even when the check valve 6 and the needle valve 7 are provided.

Furthermore, in the shock absorber D of the present embodiment, the annular valve body 62 and the biasing member 63 are positioned in the radial direction by the side wall surface of the annular recess portion 71b in the needle case 71. According to the shock absorber D configured as described above, when the entire annular valve body 62 is separated from the valve seat member 61 and seated again, axial deflection of the annular valve body 62 and the biasing member 63 in the radial direction is suppressed, so that the operation of the annular valve body 62 is stabilized and the hole 61b can be stably closed when the annular valve body 62 is seated on the valve seat member 61.

In the shock absorber D of the present embodiment, the flow path area of the needle valve 7 is adjusted by the linear actuator 100, but an adjuster capable of adjusting the position of the needle 72 in the axial direction with respect to the needle case 71 may be provided at the opening end of the first housing 11d, and the user of the shock absorber D may manually operate the adjuster to change the flow path area of the needle valve 7.

In the shock absorber D of the present embodiment, the check valve 6 and the needle valve 7 are accommodated in the first housing 11d of the upper cap 11, and the compression side damping valve 5 and the extension side check valve 10 are accommodated in the second housing 11e. However, the first housing 11d may be eliminated from the upper cap 11, the second housing 11e may be used as the housing, and the check valve 6, the needle valve 7, the compression side damping valve 5, and the extension side check valve 10 may be accommodated in the second housing 11e.

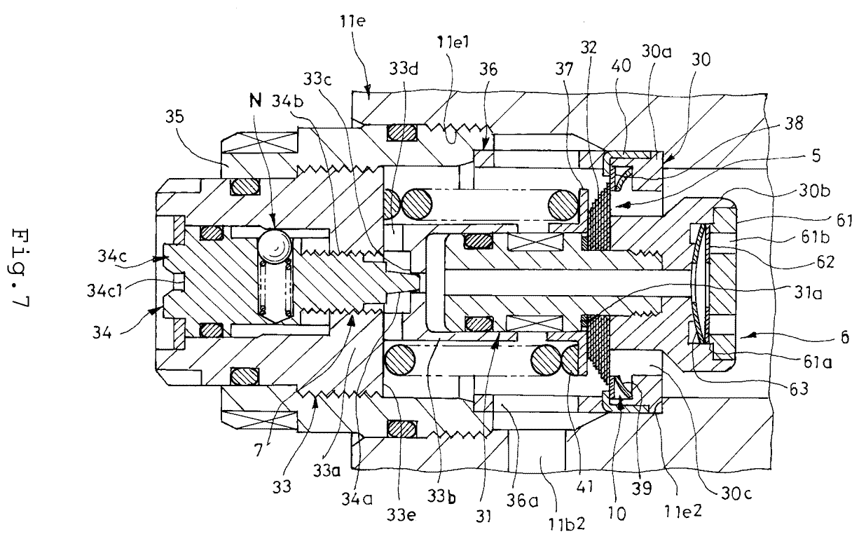

In this case, as illustrated in FIG. 7, an annular disc 30 having a port 30c, a tubular member 31 connected to the disc 30, the compression side damping valve 5 that opens and closes the port 30c, the extension side check valve 10 installed in the disc 30, the check valve 6 assembled to the disc 30, a tubular needle case 33 fitted to the outer periphery of the tubular member 31, a needle 34 accommodated in the needle case 33, a tubular adapter 35 having the inner periphery to which the needle case 33 is screwed, and which is screwed to the screw portion 11e1 in the second housing 11e, and a tubular spacer 36 interposed between the adapter 35 and the outer periphery of the disc 30 are provided.

The disc 30 includes an annular main body portion 30a that partitions the inside of the second housing 11e into a space communicating with the inside of the connection portion 11c and a space communicating with the port 11b2, an annular valve case 30b that protrudes rightward in FIG. 7 of the main body portion 30a, and a port 30c that is formed by an annular groove that opens from a left end in FIG. 7 of the main body portion 30a and a plurality of holes that open along the axial direction from a right end in FIG. 7 of the main body portion 30a and communicate with the annular groove, and allows communication between the spaces.

The check valve 6 is accommodated in the valve case 30b. Specifically, it includes the valve seat member 61 including the hole 61b immovably fixed to the valve case 30b, the annular valve body 62 accommodated in the valve case 30b and movable in the axial direction with respect to the valve seat member 61, and the biasing member 63 interposed between the bottom portion of the valve case 30b and the annular valve body 62. The check valve 6 configured as described above is accommodated in the valve case 30b and integrated with the disc 30. Then, when the check valve 6 is pushed leftward by the pressure of the compression side chamber R2 acting through the connection portion 11c and the hole 61b and the annular valve body 62 is separated from the valve seat member 61, the hole 61b is opened and the check valve 6 opens.

The tubular member 31 is screwed to the inner periphery of the disc 30 and connected to the disc 30, and the inner periphery thereof communicates with the inside of the valve case 30b. The tubular member 31 has a large outer diameter on the left side in FIG. 7 from the partway, and a step portion 31a is formed on the outer periphery of the tubular member 31. A stacked leaf valve 32 in which a plurality of annular leaf valves are stacked is fitted to the outer periphery of the tubular member 31. The inner periphery of the stacked leaf valve 32 is sandwiched between the step portion 31a of the tubular member 31 and the left end in FIG. 7 of the disc 30. The stacked leaf valve 32 has the inner peripheral side immovably fixed to the tubular member 31 in this manner, is allowed to deflect on the outer peripheral side, and partially covers the annular groove forming the port 30c of the disc 30. In addition, a spring seat 37 overlapped on the counter-disc side of the stacked leaf valve 32 is mounted to be movable in the axial direction on the outer periphery of the tubular member 31 on the left side in FIG. 7 with respect to the step portion 31a.

In the annular groove of the disc 30, the extension side check valve 10 consisting of a check valve body 38 that has an annular shape, has an inner diameter larger than the inner diameter of the annular groove, and has an outer diameter larger than the outer diameter of the stacked leaf valve 32, and a wave washer 39 that biases the check valve body 38 so as to abut on the outer periphery of the stacked leaf valve 32 is accommodated. The outer peripheral portion of the check valve body 38 is supported by an annular valve stopper 40 mounted to the outer periphery of the disc 30 so as not to fall off from the annular groove of the disc 30.

The needle case 33 has a tubular shape as a whole and includes a tubular accommodating portion 33a that accommodates the needle 34, a tubular fitting portion 33b that protrudes from the accommodating portion 33a toward the tubular member 31 and is fitted to the outer periphery of the left end in FIG. 7 of the tubular member 31, an annular valve seat 33c that is provided on the inner periphery between the accommodating portion 33a and the fitting portion 33b, and a hole 33d that is provided on the left end side in FIG. 7 with respect to the annular valve seat 33c and allows communication between the inside and outside of the accommodating portion 33a. The outer diameter of the accommodating portion 33a is larger than the outer diameter of the fitting portion 33b, and the needle case 33 includes a step portion 33e on the outer periphery.

The needle 34 is accommodated in the needle case 33, and includes a conical valve head 34a that can be seated on and separated from the annular valve seat 33c, a screw portion 34b that is connected to a left end in FIG. 7 of the valve head 34a and is screwed to an inner periphery of the needle case 33, and an operating unit 34c that is connected to a left end in FIG. 7 of the screw portion 34b, is slidably in contact with the inner periphery of the needle case 33, and includes a groove 34cl that enables insertion of a tool at a rear end.

Since the needle case 33 and the needle 34 configure the needle valve 7 and the needle 34 is screwed into the needle case 33, when the operating unit 34c is rotated, the needle 34 axially moves close to and away from the annular valve seat 33c of the needle case 33, and the flow path area in the needle valve 7 can be changed. Although not described in detail, a detent N that functions as a positioner of the needle 34 with respect to the needle case 33 in the circumferential direction and a rotation stopper by fitting a ball and a groove is provided between the needle case 33 and the needle 34.

The needle case 33 is screwed to the inner periphery of a tubular adapter 35 screwed to the screw portion 11e1 in the second housing 11e, and is fixed in the second housing 11e. The tubular spacer 36 having a through-hole 36a is interposed between the adapter 35 and the outer peripheral portion of the disc 30, and when the adapter 35 is screwed into the second housing 11e, the spacer 36 and the disc 30 are sandwiched between the adapter 35 and the step portion 11e2 provided in the partway of the second housing 11e. In this manner, the adapter 35 connects the needle case 33 to the second housing 11e and fixes the disc 30 to the second housing 11e.

A coil spring 41 is interposed in a compressed state between the step portion 33e on the outer periphery of the needle case 33 fixed in the second housing 11e and the spring seat 37 mounted on the outer periphery of the tubular member 31 assembled to the disc 30 in this manner. The coil spring 41 constantly biases the stacked leaf valve 32 toward the disc 30 via the spring seat 37.

When the outer periphery of the stacked leaf valve 32 abuts on the disc 30, the stacked leaf valve 32 covers the inner peripheral side of the annular groove forming the port 30c of the disc 30, the inner peripheral side of the check valve body 38 accommodated in the annular groove abuts on the outer periphery of the stacked leaf valve 32 on the disc side, and the outer periphery of the check valve body 38 on the counter-disc side abuts on the valve stopper 40, so that the port 30c is closed. On the other hand, when the outer periphery of the stacked leaf valve 32 is deflected and separated from the disc 30, the stacked leaf valve 32 is also separated from the check valve body 38 to open the port 30c. In this manner, the check valve body 38 also functions as a valve seat of the stacked leaf valve 32.

The port 30c communicates with the compression side chamber R2 via the inside of the connection portion 11c, and communicates with the tank 4 via the through-hole 36a of the spacer 36 and the port 11b2. During the contraction stroke of the shock absorber D, when the outer periphery of the stacked leaf valve 32 is deflected by the pressure in the compression side chamber R2 acting via the port 30c, the outer periphery of the stacked leaf valve 32 is separated from the check valve body 38 and the disc 30, and the port 30c is opened, so that the hydraulic oil can move from the compression side chamber R2 toward the tank 4. In addition, the stacked leaf valve 32 applies resistance to the flow of the hydraulic oil passing through the port 30c. The deflection amount of the stacked leaf valve 32 can be tuned by setting the deflection stiffness of the stacked leaf valve 32 and the spring constant of the coil spring 41. In this manner, the disc 30, the stacked leaf valve 32, the check valve body 38, the spring seat 37, and the coil spring 41 form the compression side damping valve 5.

Note that the configurations of the compression side damping valve 5 and the extension side check valve 10 are merely examples, and other configurations may be adopted, and can be changed in design.

With respect to the flow of the hydraulic oil from the compression side chamber R2 toward the tank 4, the check valve body 38 is regulated by the valve stopper 40 and positioned at the opening of the annular groove, but since the inner diameter is larger than the inner diameter of the annular groove, the flow of the hydraulic oil is allowed.

On the other hand, during the extension stroke of the shock absorber D, the outer periphery of the stacked leaf valve 32 is in a state in which it abuts on the disc 30, but the check valve body 38 receives the pressure from the tank 4, compresses the wave washer 39, moves to the bottom portion side in the annular groove, separates from the stacked leaf valve 32, and opens the port 30c. In this manner, the compression side damping valve 5 applies resistance to the flow of the hydraulic oil from the compression side chamber R2 toward the tank 4 through the port 30c, and the extension side check valve 10 allows the flow of the hydraulic oil from the tank 4 toward the compression side chamber R2 through the port 30c.

The compression side chamber R2 and the tank 4 communicate with each other via the inside of the connection portion 11c, the hole 61b in the check valve 6, the inside of the disc 30, the inside of the tubular member 31, the inside of the needle case 33, the hole 33d, the through-hole 36a of the spacer 36, and the port 11b2. The hole 61b in the check valve 6, the inside of the disc 30, the inside of the tubular member 31, the inside of the needle case 33, and the hole 33d form the bypass passage PB.

During the contraction stroke of the shock absorber D, when the needle valve 7 is opened, the check valve 6 is opened, and the hydraulic oil can move from the compression side chamber R2 to the tank 4 through the needle valve 7. On the other hand, during the extension stroke of the shock absorber D, since the check valve 6 is closed, the hydraulic oil cannot pass through the bypass passage PB and moves from the tank 4 to the compression side chamber R2 through the extension side check valve 10.

In this manner, the first housing 11d is eliminated from the upper cap 11, the second housing 11e is used as a housing, and the check valve 6, the needle valve 7, the compression side damping valve 5, and the extension side check valve 10 can be accommodated in the second housing 11e. The second housing 11e in the upper cap 11 may be eliminated to use the first housing 11d as a housing, and the check valve 6, the needle valve 7, the compression side damping valve 5, and the extension side check valve 10 may be accommodated in the first housing 11d.

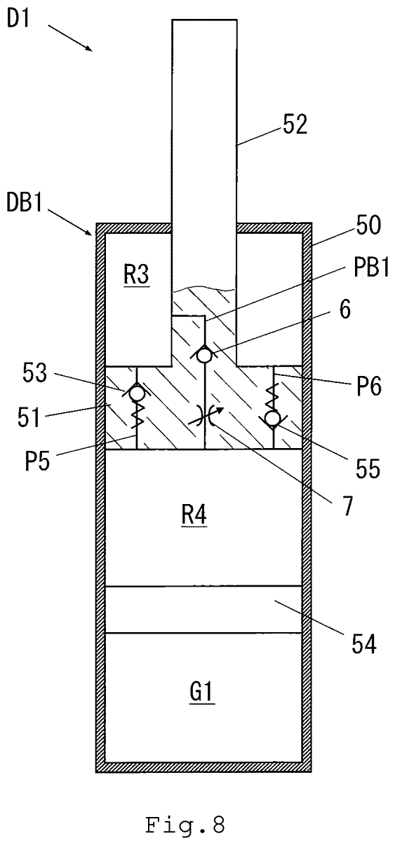

In the shock absorber D described above, the first passage P1 and the bypass passage PB allow communication between the compression side chamber R2 and the tank 4, with the operation chambers as the compression side chamber R2 and the tank 4. However, as illustrated in FIG. 8, the extension side chamber R3 and the compression side chamber R4 in a shock absorber main body DB1 may communicate with each other using the bypass passage PB, with the operation chambers as an extension side chamber R3 and a compression side chamber R4, a damping valve may be provided in the first passage P1, and the check valve 6 and the needle valve 7 may be provided in series with the bypass passage PB. A shock absorber D1 illustrated in FIG. 8 includes the shock absorber main body DB1 including the cylinder 50, the piston 51 inserted so as to be movable in the axial direction in the cylinder 50, the piston rod 52 inserted so as to be movable in the axial direction in the cylinder 50 and connected to the piston 51, the extension side chamber R3 and the compression side chamber R4 partitioned by the piston 51 in the cylinder 50, a first passage P5 and a bypass passage PB1 that allow communication between the extension side chamber R3 and the compression side chamber R4, a damping valve 53 that is provided in the first passage P5 and allows only the flow of the hydraulic oil from the extension side chamber R3 toward the compression side chamber R4 and to apply resistance to the flow of the hydraulic oil passing therethrough, the check valve 6 that is provided in the bypass passage PB1 and allows only the flow of the hydraulic oil from the extension side chamber R3 toward the compression side chamber R4, and the needle valve 7 that is provided in the bypass passage PB1 in series with the check valve 6 and capable of changing the flow path area. In the case of the shock absorber D1, the extension side chamber R3 and the compression side chamber R4 serve as the operation chambers.

In the cylinder 50 in the shock absorber main body DB, a free piston 54 that partitions a gas chamber G1 filled with gas is inserted so as to be movable in the axial direction in the cylinder 50 on the counter-extension side chamber side of the compression side chamber R4, and the piston 51 is provided with a compression side passage P6 that allows communication between the extension side chamber R3 and the compression side chamber R4 in parallel with the first passage P5, and a compression side valve 55 that applies resistance to the flow of the hydraulic oil from the compression side chamber R4 toward the extension side chamber R3 in the compression side passage P6.

The shock absorber D1 configured as described above is configured as a monotube shock absorber. Then, in a case where the extension side chamber R3 and the compression side chamber R4 are used as the operation chambers and the extension side chamber R3 and the compression side chamber R4 of the shock absorber D1 communicate with each other by the bypass passage PB1, when the bypass passage PB1, the check valve 6, and the needle valve 7 are provided in the piston rod 52 as illustrated in the drawing, it is possible to install the bypass passage PB1, the check valve 6, and the needle valve 7 while avoiding an increase in the outer diameter of the shock absorber D1. When the needle valve 7 is provided in the piston rod 52 in this manner, the piston rod 52 may be formed in a tubular shape, and power for changing the flow path area may be applied to the needle valve 7 by using a control rod inserted into the piston rod 52.

When the shock absorber D1 extends, since the hydraulic oil passes through the damping valve 53 and moves from the extension side chamber R3 to the compression side chamber R4, and the check valve 6 opens, the hydraulic oil passes through the check valve 6 and the needle valve 7 and moves from the extension side chamber R3 to the compression side chamber R4. Therefore, in the shock absorber D1 configured as described above, the damping valve 53 and the needle valve 7 apply resistance to the flow of the hydraulic oil to generate a damping force that hinders the extension of the shock absorber main body DB1. Since the resistance applied to the flow of the hydraulic oil by the needle valve 7 can be changed by changing the flow path area of the needle valve 7, it is possible to adjust the damping force during the extension stroke of the shock absorber D. The volume change in the cylinder 50 due to the piston rod 52 retracting from the cylinder 50 during the extension stroke of the shock absorber D1 is compensated by the free piston 54 moving in the cylinder 50 to expand the gas chamber Gl.

On the other hand, when the shock absorber D1 contracts, the hydraulic oil passes through the compression side valve 55 and moves from the compression side chamber R4 to the extension side chamber R3. Since the check valve 6 is not opened during the contraction stroke of the shock absorber D1, the hydraulic oil cannot pass through the bypass passage PB1 in which the needle valve 7 is installed and moves only through the compression side valve 55. Therefore, in the shock absorber D1 configured as described above, since the damping force that hinders the contraction of the shock absorber main body DB1 is generated by applying resistance to the flow of the hydraulic oil only by the compression side valve 55, the needle valve 7 does not affect the damping force during the contraction stroke at all. The volume change in the cylinder 50 due to the piston rod 52 entering the cylinder 50 during the contraction stroke of the shock absorber D1 is compensated by the free piston 54 moving in the cylinder 50 to reduce the gas chamber G1.

According to the shock absorber D1 configured as described above, even when the damping force in the extension stroke of the shock absorber D1 is adjusted by changing the flow path area of the needle valve 7, the damping force in the contraction stroke of the shock absorber D is not changed. Therefore, only the damping force at the time of extension can be changed even when the needle valve 7 is provided.

When the direction in which the hydraulic oil allowed by the check valve 6 is directed in the shock absorber D1 is reversed, that is, in a case where the check valve 6 is set to allow only the flow of the hydraulic oil from the compression side chamber R4 toward the extension side chamber R3, the hydraulic oil passes through not only the compression side valve 55 but also the needle valve 7 when the shock absorber D1 contracts, and the hydraulic oil passes only through the damping valve 53 when the shock absorber D1 extends. With this setting, the damping force in the contraction stroke of the shock absorber D1 can be adjusted by changing the flow path area of the needle valve 7, and the damping force in the extension stroke of the shock absorber D is not changed. In this case, the compression side valve 55 functions as a damping valve, and the compression side passage P6 in which the compression side valve 55 is provided functions as a first passage. According to the shock absorber D1 configured as described above, even when the damping force in the contraction stroke of the shock absorber D1 is adjusted by changing the flow path area of the needle valve 7, the damping force in the extension stroke of the shock absorber D is not changed. Therefore, only the damping force at the time of contraction can be changed even when the needle valve 7 is provided.

Although a preferred embodiment of the present invention has been described above in detail, modifications, variations, and changes can be made without departing from the claims.

### REFERENCE SIGNS LIST

1, 50 Cylinder
51 Piston
52 Piston rod
4 Tank (operation chamber)
5 Compression side damping valve (damping valve)
6 Check valve
7 Needle valve
8 Extension side damping valve
9 Compression side check valve
10 Extension side check valve
11d First housing (housing)
11e Second housing (housing)
33, 71 Needle case
34, 72 Needle
53 Damping valve
61 Valve seat member
61b Hole
62 Annular valve body
63 Biasing member
71b Annular recess portion
71f Annular valve seat
D1 Shock absorber
DB, DB1 Shock absorber main body
P1, P5 First passage
P2 Second passage
P3 Third passage
P4 Suction passage
PB, PB1 Bypass passage
R1 Extension side chamber
R2 Compression side chamber (operation chamber)
R3 Extension side chamber (operation chamber)
R4 Compression side chamber (operation chamber)

1. A shock absorber comprising:
a shock absorber main body having a cylinder, a piston inserted into the cylinder so as to be movable in an axial direction, a piston rod inserted into the cylinder and connected to the piston, and a plurality of operation chambers filled with liquid;
a first passage and a bypass passage that allow communication between the operation chambers;
a damping valve that is provided in the first passage and applies, while allowing only a flow of liquid from one operation chamber toward the other operation chamber, resistance to the flow of the liquid;
a check valve that is provided in the bypass passage and allows only the flow of liquid from one operation chamber toward the other operation chamber; and
a needle valve that is provided in the bypass passage in series with the check valve and capable of changing a flow path area.

2. The shock absorber according to claim 1,
the shock absorber main body having
an extension side chamber and a compression side chamber partitioned by the piston in the cylinder, and
a tank that stores liquid,
the shock absorber comprising:
a second passage and a third passage that allow communication between the extension side chamber and the compression side chamber in parallel;
a suction passage that allows communication between the compression side chamber and the tank;
an extension side damping valve that is provided in the second passage and applies resistance to a flow of liquid from the extension side chamber toward the compression side chamber;
a compression side check valve that is provided in the third passage and allows only a flow of liquid from the compression side chamber toward the extension side chamber; and
an extension side check valve that is provided in the suction passage and allows only a flow of liquid from the tank toward the compression side chamber, wherein
the first passage and the bypass passage allow communication between the compression side chamber and the tank, with the operation chambers as the compression side chamber and the tank,
the damping valve applies, while allowing only a flow of liquid from the compression side chamber toward the tank, resistance to the flow of the liquid, and
the check valve allows only the flow of liquid from the compression side chamber toward the tank.

3. The shock absorber according to claim 1, further comprising:
a housing that accommodates the check valve and the needle valve, wherein
the needle valve includes
a needle case having a tubular shape and inserted into the housing, and
a needle inserted into the needle case so as to be movable in the axial direction,
the needle case has an annular recess portion formed by expanding an inner diameter at one end,
the check valve has
a disk-shaped valve seat member that is sandwiched between one end side of the needle case and the housing, faces the annular recess portion, is in close contact with the needle case and the housing, and includes a hole that penetrates a wall thickness,
an annular valve body that is accommodated in the annular recess portion so as to be movable in the axial direction and is seated on and separated from the valve seat member, and
an annular biasing member that is accommodated in the annular recess portion and biases the annular valve body toward the valve seat member, and
the bypass passage allows communication between the operation chambers via the hole and an inside of the needle case.

4. The shock absorber according to claim 3, wherein
the needle case has an annular valve seat on its inner periphery on which the needle is seated and separated.

5. The shock absorber according to claim 3, wherein
the annular valve body and the biasing member are positioned in a radial direction by a side wall surface of the annular recess portion in the needle case.
